(19) United States
(12) Patent Application Publication
(10) Pub. No.: US 2023/0238553 A1
(43) Pub. Date: Jul. 27, 2023

(54) FUEL CELL STACK

(71) Applicant: CELLCENTRIC GMBH & CO. KG, Kirchheim unter Teck (DE)

(72) Inventors: Viktoria FRICK, Neuhausen auf den Fildern (DE); Philipp HAUSMANN, Kirchheim (DE); Simon HOLLNAICHER, Albershausen (DE); Michael PROCTER, Vancouver (CA)

(21) Appl. No.: 18/042,805

(22) PCT Filed: Jul. 29, 2021
(86) PCT No.: PCT/EP2021/071261

§ 371 Date: Feb. 24, 2023

(30) Foreign Application Priority Data
Aug. 27, 2020 (DE) 10 2020 005 246.0

(51) Int. Cl. H01M 8/04119; H01M 8/04007; H01M 8/04111

(52) U.S. Cl. CPC H01M 8/04149; H01M 8/04074; H01M 8/04111; H01M 2008/1095

(57) ABSTRACT

The invention relates to a fuel cell stack having a variety of individual cells stacked up to form a stack, having at least one humidifier section integrated into the stack and arranged at one end of the individual cells as an electrochemical section. The invention is characterized in that a heat exchanger section is arranged on the side of the at least one humidifier section facing away from the electrochemical section, wherein flow plates for distributing fluids in at least three sections of the stack have the same external geometry.

The invention relates to a fuel cell stack having a variety of individual cells stacked up to form a stack, according to the type defined in more detail in the preamble of claim 1.

In addition to the actual fuel cell stack having its electrochemically active individual cells, various peripheral components are necessary for the operation of fuel cell stacks. These comprise in particular components for processing the supply air used as an oxygen supplier and can comprise charge air coolers and humidifiers. In this context, DE 10 2007 038 880 A1 of the applicant describes a fuel cell arrangement having a fuel cell stack, a charge air cooler, and a humidifier, which are combined to form a structural unit.

DE 10 2007 008 214 B4 therefore describes the integration of a humidifier in each individual electrochemical cell, which involves considerable effort, however.

On the other hand, a simplification is offered by a structure in which flow plates comparable to those used for the construction of the individual electrochemical cells can also be used for the humidifier. These can then be integrated into the stack of individual cells relatively easily and significantly more efficiently than in the document mentioned at the outset, in which various components are combined. Such a structure is described in U.S. Pat. No. 5,200,278 A.

The object of the present invention is to still further optimize a fuel cell stack in order to be able to implement a fuel cell system equipped with it in a compact and cost-effective manner.

According to the invention, this object is achieved by a fuel cell stack having the features in claim 1, and here in particular in the characterizing part of claim 1. Advantageous embodiments and refinements result from the subclaims dependent thereon.

In the case of the fuel cell stack according to the invention, comparably to the fuel cell stack in the last-mentioned prior art, it comprises a variety of stacked individual cells, and a humidifier is integrated into the stack and is arranged at one end of the individual cells. In principle, two humidifiers at both ends of the individual cells of the stack would also be conceivable. According to the invention, a charge air cooler is arranged on the side of the at least one humidifier facing away from the individual cells. Flow plates, which are provided for distributing fluids in the at least three sections of the stack, have the same external geometry in the fuel cell stack according to the invention. The flow plates used are therefore designed identically with regard to their external geometry, so that they can be stacked up to form an overall stack without any problems. The concepts for sealing between the individual flow plates and for connecting the individual cells and the sections of the overall stack can be transferred from the previous electrochemical individual cells to the further sections of the humidifier and the charge air cooler.

This results in a very simple structure, which can be implemented in a compact and cost-effective manner by integrating the humidifier and charge air cooler into the fuel cell stack and using the same geometry for all flow plates.

According to an extraordinarily favorable refinement of the fuel cell stack according to the invention, it is thereby provided that flow occurs through the flow plates of each section in parallel and through the at least three sections in series, wherein the inflowing air first flows through the charge air cooler, then through the humidifier, and then through the cathode side of the individual cells. This design ensures that the entire incoming airflow is evenly cooled and humidified before entering the individual cells. In principle, this structure could also be transferred to the hydrogen flow, which would be preheated accordingly after expansion and then humidified, wherein in general humidification of the air flow, which is much larger in terms of its volume flow, is sufficient to sufficiently humidify the membranes of the individual cells implemented in PEM technology.

According to a very advantageous refinement of the fuel cell stack according to the invention, it is also provided that the connection openings of the flow plates of the at least three sections have the same geometry, wherein distributor plates for the media are attached between the sections. The connection openings, which typically form a continuous volume in a stack for distributing the media to the flow fields of the individual cells through which flow occurs in parallel, are therefore preferably embodied identically in all flow plates. This means that each flow plate includes an opening corresponding to the anode-side inflow opening and outflow opening, an opening corresponding to the cathode-side inflow and outflow opening, and an opening corresponding to the cooling medium inflow and outflow opening analogously to the flow plates of the individual electrochemical cells. In order to ensure that the flow through the sections, which is conceived according to the advantageous embodiment described above, takes place in series, corresponding distributor plates for the media are then arranged between the sections, which provide the possibly necessary deflection of the flow and ensure the sealing of the channels of the sections formed by the aligned connection openings in relation to one another or, for example, also ensure this correspondingly at the connection openings for the cooling medium, if this is solely conducted through the area of the charge air cooler and/or the humidifier.

Another very favorable embodiment of the fuel cell stack according to the invention provides that in the section used as a charge air cooler, thermally conductive, temperature-resistant foils are arranged between each two flow plates, through which the inflowing gas and the outflowing gas flow alternately. The individual flow plates can thus be designed for the section of the heat exchanger as well as for the section of the humidifier in such a way that flow channels for one of the gas flows, for example the supplied gas, are formed on their one surface and flow channels for the outflowing gas are formed on their opposite side. The plates are then arranged mutually twisted, so that the thermally conductive, temperature-resistant foils are positioned between the plates in the case of the heat-exchanging section and membranes permeable to water vapor are positioned between the plates in the case of the section used as a humidifier. This enables a simpler and more efficient structure.

The structure can be implemented on one or both sides of the individual cells at the respective stack ends. This can also contribute to the fact that the thermal management of the individual cells in the end area of the stack is improved accordingly, because they are now adjacent to the humidifiers and do not cool down more due to their arrangement adjacent to the end plates of the stack, which is sometimes difficult in structures according to the prior art. This further simplifies the structure of the end plates, since electrical heating thereof can be dispensed with in a structure of the stack according to the invention, at least if they are not arranged adjacent to the individual cells, but rather adjacent to the structure made up of charge air cooler and humidifier.

In the section of the fuel cell stack used as an charge air cooler, a structure can also be implemented additionally or alternatively to the structure described for heat exchange between the inflowing and outflowing gas, which, comparable to the structures of the flow fields in the electrochemical cells, has these in such a way that on one side they have a flow field for one of the media and on their other side they have a flow field for a cooling medium. If two such panels are connected to one another back-to-back, a structure is created in which, for example, the supply air can flow on one side and the exhaust air can flow on the other side of the sandwich, with a cooling medium flowing in between. If these are in turn arranged alternately with the foils arranged in between, for example made of metal or graphite, on the one hand heat exchange takes place between the media through these foils and on the other hand there is additional temperature control, in particular additional cooling by the cooling medium, which has already been used for cooling the individual cells. Ideally, the flow is such that the cooling medium first flows through the individual cells and then through a section of the fuel cell stack constructed in this way, which is used as a charge air cooler.

This may also be implemented comparably in the area of the humidifier, so that here too the structures can be implemented corresponding to those of the electrochemical individual cells, but without the gas diffusion layers and catalysts. In principle, the same membranes could even be used here, wherein a further advantage is to be achieved here by more cost-effective membranes. The cooling medium could also be used here to cool the inflowing gases during humidification.

It is the case that fuel cell stacks of this type can preferably be designed using PEM technology and are used in particular, but not exclusively, in vehicles. In such vehicles, for example in passenger vehicles or utility vehicles, such as trucks in particular, they are used to provide electrical drive power from entrained hydrogen and air sucked in from the surroundings as an oxygen supplier.

Further advantageous embodiments of the fuel cell stack according to the invention result from the exemplary embodiments which are described in more detail hereinafter with reference to the figures.

### IN THE FIGURES

FIG. 1 shows a schematic representation of a first possible embodiment of a fuel cell stack according to the invention;

FIG. 2 shows an alternative possible embodiment of a fuel cell stack according to the invention in a representation similar to that in FIG. 1;

FIG. 3 shows a top view of a flow plate as can be used, for example, in the area of the section used as a charge air cooler or humidifier;

FIG. 4 shows a schematic sectional view through a section of flow plates in the section used as a charge air cooler and/or humidifier having flow plates according to FIG. 3;

FIG. 5 shows a flow plate similar to that in FIG. 3 in an alternative embodiment; and

FIG. 6 shows a structure similar to that in FIG. 4 having flow plates according to the structure shown in FIG. 5.

In the representation of FIG. 1, a possible structure of a fuel cell stack 1 is shown in an embodiment according to the invention. There are three sections between two end plates designated by 2. An electrochemical section 3, which is provided with a variety of individual cells for providing the electrical power. This section 3 consists of stacked individual cells in PEM technology and essentially corresponds to a conventional fuel cell stack or fuel cell stack, respectively. A humidifier section 4 is located adjacent, followed by a heat exchanger section 5. The humidifier section 4 is used to humidify the supply air flowing into the electrochemical section 3 in which moisture from the exhaust air of the electrochemical section 3 is used for humidification. The structure is a plate humidifier having membranes 22 permeable to water vapor, which are shown later.

The heat exchanger section 5 is used as an charge air cooler in order to correspondingly cool the supply air, which is typically hot and dry after its compression, for example from temperatures of 200 to 250° C., which are typical after compression, to a temperature level of approximately 100° C., for example 80 to 120° C. The flow path is now shown by the arrows. The supply air flows into the heat exchanger section 5 on one side thereof at the point designated by 6 and flows through it. It is then deflected by a distribution plate (not shown here) after it has flowed through the flow plates of the heat exchanger section 5 in parallel. Now it flows in series through the humidifier section 4, within which it also flows through the individual flow plates in parallel to one another. The supply air flow cooled and humidified in this way then arrives in the area of a further distribution plate and at the point designated here as 7 in the electrochemical section 3 and flows through its individual cells in parallel. The moist exhaust air from the electrochemical section 3 then returns to the humidifier section 4 at the point designated 8 and releases the moisture contained therein to the supply air. The exhaust air then flows into the heat exchanger section 5 and absorbs heat from the supply air flow before it flows out of the fuel cell stack 1 again at point 9.

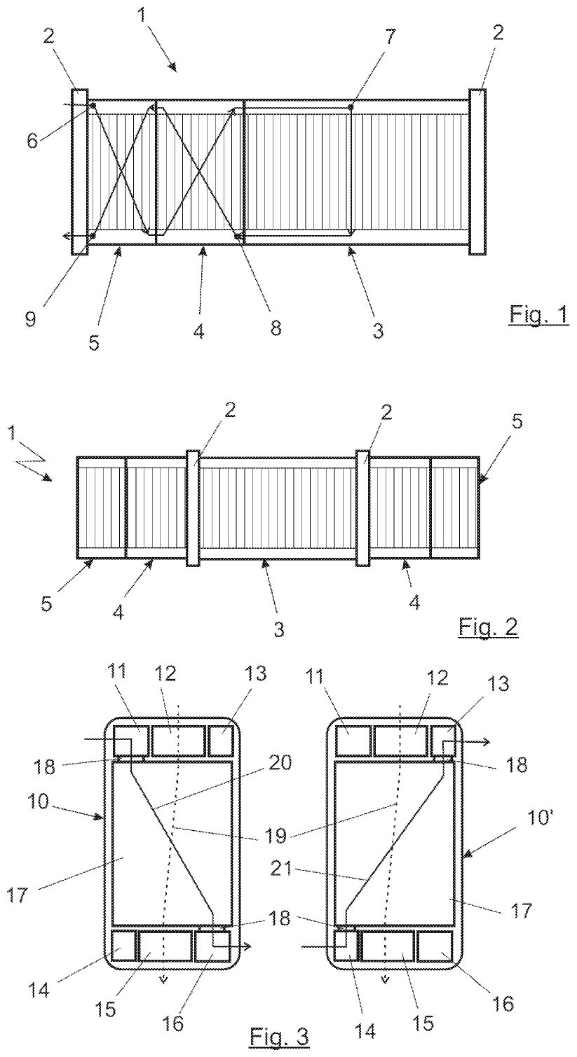

In the exemplary embodiment shown here, this entire structure is provided at one end of the electrochemical section 3 and is integrated between the end plates 2 of the structure. Alternatively, thereto, the structure could also be designed as indicated in FIG. 2. In this case, the structure is correspondingly integrated at both ends of the electrochemical section 3, without the flow being explicitly drawn again here, which makes additional connecting lines necessary. In addition, the two end plates 2 are arranged in a conventional manner directly adjacent to the electrochemical section 3, while the humidifier sections 4 and the heat exchanger sections 5 are provided as charge air coolers outside the end plates 2 on both sides. Both structures according to FIGS. 1 and 2 can be combined with one another as desired, so the structure could also be provided on both sides of the electrochemical section 3 inside the end plates 2, for example, or only on one side, similarly to the representation in FIG. 1 but outside of the end plate 2, as indicated in FIG. 2.

The individual sections 3, 4, 5 now comprise flow plates 10, 10′. These flow plates 10, 10′, which are often designed as bipolar plates, are fundamentally known to the person skilled in the art from the field of the electrochemical section and here of the individual cells. This type of flow plates can now also be used largely identically in the other sections 4, 5, wherein it is also possible in particular here to switch to more cost-effective materials and manufacturing processes for the flow plates, but without changing the geometry thereof, and this relates in particular to the external geometry and the geometry of connection openings. The entire structure can then be stacked in the manner known from the electrochemical section 3 and sealed via seals between the individual flow plates 10, 10′ easily, reliably, and in the manner known per se.

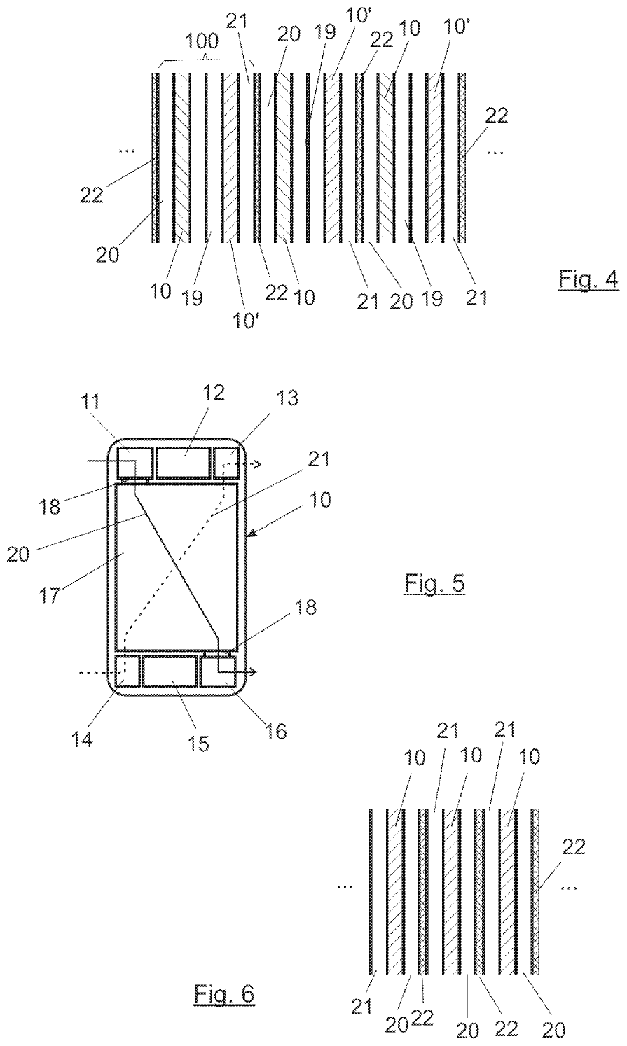

A top view of a possible structure of two such flow plates 10, 10′ can be seen in the representation of FIG. 3. They comprise three connection openings on each side. These connection openings are designated by reference numerals 11, 12, and 13 on one side and 14, 15, 16 on the other side. In the case of the flow plate 10 shown here on the left, the connections 11 and 16 on the side facing the viewer are now to be connected to one another via a flow field 17, which is indicated accordingly by the corresponding areas between the flow field 17 and the respective connection openings 11 and 16, the so-called manifolds 18. A flow channel designated by 20 is thus formed. The two cooling water connections 12, 15 are then connected to one another on the opposite side of the flow plate 10, which is not visible here. A cooling medium channel designated by 19 is thus formed. On the next flow plate 10′, which is shown here on the right, the cooling water connections 12 and 15 are in turn connected to one another on one side, while the connections 13 and 14 are connected to one another on the visible side. A flow channel designated by 21 is thus formed. As is known from the area of the flow plates 10, 10′ in the electrochemical section 3, these flow plates 10, 10′ are now positioned with their backs against one another, so that the channel 19 for the cooling medium is created between the flow plates 10, 10′. If these structures 100 made up of flow plates 10, 10′ connected to one another are stacked in mirror image to one another, the channels 20 through which one medium flows and the channels 21 through which the other medium flows always lie opposite to one another between the individual structures 100 made up of flow plates 10, 10′. This can be seen in the schematic sectional illustration of FIG. 4 through a small section of the respective section 4, 5. Between the individual plates 10, 10′ of the structure 100, the channel for the cooling medium, designated by 19 here, results on one side of the structure, for example on the surface of the flow plate 10, the channel designated by 20 for one medium results on the opposite side on the surface of the other flow plate 10′ in a channel for the other medium. This is designated by 21. A membrane or foil 22 is now arranged between the channels 20, 21 for the one and the other medium, and it can thus be seen in the illustration of FIG. 4. In the area of the humidifier section 4, this membrane or foil 22 can be a membrane permeable to water vapor, which thus enables an exchange of water vapor between the media flowing in the channel 20 and 21. Therefore, the dry supply air and the moist exhaust air are conducted in the respective channels 20, 21 in order to be able to humidify the dry supply air in the humidifier section 4 by way of the moist exhaust air. In the area of the heat exchanger section 5, such membranes are typically unsuitable because they do not withstand the relatively high temperatures of the compressed, dry, and hot supply air, or do not do so in the long term. For this reason, metal foils and graphite foils can be used as a membrane or foil 22 or the like, which are correspondingly temperature-resistant and enable good heat exchange between the hot supply air and the much cooler exhaust air. In addition, temperature control can also be achieved in both cases via the cooling medium flowing in the cooling channel 19, similarly to the structure of the individual cells in the electrochemical area 3.

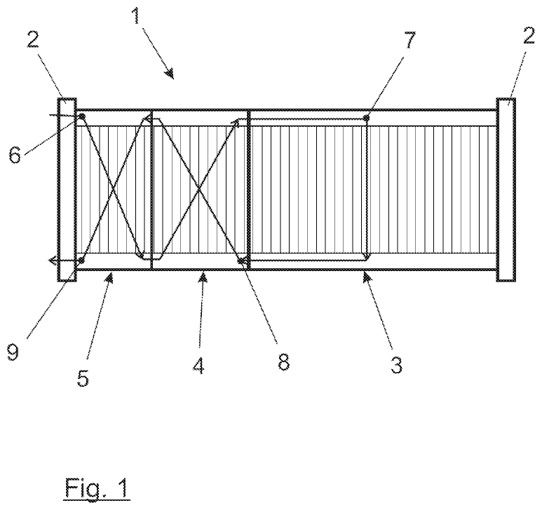

As an alternative to this structure described in FIGS. 3 and 4, however, a variant is also conceivable which is of correspondingly simpler design and dispenses with the additional through-flow of cooling medium and the cooling channel 19 required for this. Only a single flow plate 10 is then necessary for this purpose, as indicated accordingly in the representation of FIG. 5. This flow plate 10 corresponds in its geometry to the previously shown flow plate 10. On the back, which cannot be seen here, it is not the openings 12 and 15 that are connected to one another, but the openings 13 and 14, so that a structure is created, so to speak which has on one side the one side of the above-described flow plate 10 and on the other side the one side of the above-described flow plate 10′. These flow plates 10 can now be stacked directly alternately mirrored to one another with the membranes or foils 22, as is indicated in the illustration in FIG. 6 similarly to the illustration in FIG. 4. This structure can be implemented even more simply and compactly and can, in particular, manage without active cooling of the sections 4 and 5. It would of course also be conceivable to actively cool only one of the sections, i.e., to design the structure according to FIGS. 3 and 4 and not the other of the sections, and to carry out the structure there according to FIGS. 5 and 6.

It is the case that the typical geometry of the connection openings 11 to 16 can also be used here in order to keep the geometry of the stack the same over all sections 3, 4, 5, in particular in the case of an integrated arrangement between the end plates. The openings 12 and 15 typically provided for the cooling water can then, for example, not be used or can also be combined with other openings. For example, the openings 11 and 12 can be used as a common inflow opening for one medium and accordingly the openings 15 and 16 can be used as common outflow openings. This can be done, for example, by connecting the individual openings in the top and bottom areas to one another, or the openings can each be connected to the flow field 17 with their own manifolds 18. In principle, it is also conceivable to provide separate sections for one and the other flow within the flow field 17. All variants are conceivable and possible here, in particular according to the design of the humidifier section 4 or heat exchanger section 5 and the volume flows and flow cross sections required according to this design in the respective sections 4, 5.

1. A fuel cell stack having a variety of individual cells stacked up to form a stack, having at least one humidifier section integrated into the stack, which is arranged at one end of the individual cells as an electrochemical section,
wherein on the side of the at least one humidifier section facing away from the electrochemical section, a heat exchanger section is arranged, wherein flow plates for distributing fluids in the at least three sections of the stack have the same external geometry,
wherein in the heat exchanger section, thermally conductive, temperature-resistant foils are arranged between two flow plates, through which the inflowing gas and outflowing gas flow alternately.

2. The fuel cell stack as claimed in claim 1,
wherein
flow occurs through the flow plates of each section in parallel and flow occurs through the at least three sections in series, wherein inflowing, compressed air flows first through the heat exchanger section, then through the humidifier section, and then through a cathode side of the electrochemical section.

3. The fuel cell stack as claimed in claim 1,
wherein
the connection openings of the flow plates of the at least three sections have the same geometry, wherein distributor plates for the media are arranged between the sections.

4. canceled.

5. The fuel cell stack as claimed in claim 1,
wherein
membranes which are permeable to water vapor are arranged in the humidifier section between each two flow plates, through which the inflowing gas and outflowing gas flow alternately.

6. The fuel cell stack as claimed in claim 5,
wherein
two of the flow plates which each have cooling medium channels on their back are combined to form a structure, on one side of which the inflowing gas flows and on the other side of which the outflowing gas flows.

7. The fuel cell stack as claimed in claim 1,
wherein
the flow plates of the heat exchanger section and/or the humidifier section have flow fields, in particular similar to the flow fields in the electrochemical section, wherein the flow fields on each of the surfaces are connected to different connection openings and are alternately stacked with membranes and/or foils arranged in between.

8. The fuel cell stack as claimed in claim 1,
wherein
the humidifier sections and heat exchanger sections are arranged at one end of the electrochemical section.

9. The fuel cell stack as claimed in claim 1,
wherein
the humidifier sections and heat exchanger sections are arranged at both ends of the electrochemical section.

10. A use of a fuel cell stack as claimed in claim 1 for providing electrical power in an at least partially electrically driven vehicle.

11. The fuel cell stack as claimed in claim 2, wherein the connection openings of the flow plates of the at least three sections have the same geometry, wherein distributor plates for the media are arranged between the sections.

12. The fuel cell stack as claimed in claim 2, wherein membranes which are permeable to water vapor are arranged in the humidifier section between each two flow plates, through which the inflowing gas and outflowing gas flow alternately.

13. The fuel cell stack as claimed in claim 3, wherein membranes which are permeable to water vapor are arranged in the humidifier section between each two flow plates, through which the inflowing gas and outflowing gas flow alternately.

14. The fuel cell stack as claimed in claim 3, wherein membranes which are permeable to water vapor are arranged in the humidifier section between each two flow plates, through which the inflowing gas and outflowing gas flow alternately.

15. The fuel cell stack as claimed in claim 2, wherein the flow plates of the heat exchanger section and/or the humidifier section have flow fields, in particular similar to the flow fields in the electrochemical section, wherein the flow fields on each of the surfaces are connected to different connection openings and are alternately stacked with membranes and/or foils arranged in between.

16. The fuel cell stack as claimed in claim 3, wherein the flow plates of the heat exchanger section and/or the humidifier section have flow fields, in particular similar to the flow fields in the electrochemical section, wherein the flow fields on each of the surfaces are connected to different connection openings and are alternately stacked with membranes and/or foils arranged in between.

17. The fuel cell stack as claimed in claim 3, wherein the humidifier sections and heat exchanger sections are arranged at one end of the electrochemical section.

18. The fuel cell stack as claimed in claim 5, wherein the humidifier sections and heat exchanger sections are arranged at both ends of the electrochemical section.

19. The fuel cell stack as claimed in claim 6, wherein the humidifier sections and heat exchanger sections are arranged at both ends of the electrochemical section.

20. The fuel cell stack as claimed in claim 7, wherein the humidifier sections and heat exchanger sections are arranged at both ends of the electrochemical section.

21. A use of a fuel cell stack as claimed in claim 2, for providing electrical power in an at least partially electrically driven vehicle.
